(19) United States
(12) Patent Application Publication
(10) Pub. No.: US 2026/0244527 A1
(43) Pub. Date: Aug. 20, 2026

(54) LOG FILTERING USING LOG TEMPLATES

(71) Applicant: Hewlett Packard Enterprise Development LP, Spring, TX (US)

(72) Inventors: Gavin Brebner, St. Martin D'Uriage (FR); Thavamani Raja Sakthivel, Bangalore (IN)

(21) Appl. No.: 19/171,598

(22) Filed: Apr. 7, 2025

(30) Foreign Application Priority Data
Feb. 20, 2025 (EP) 25305233.6

(51) Int. Cl. G06F 11/07; G06F 11/30; G06F 11/34

(52) U.S. Cl. CPC G06F 11/0793; G06F 11/0781; G06F 11/3072; G06F 11/3476

(57) ABSTRACT

In some examples, a system computes scores for log templates mapped to log entries containing log data, where a score computed for a respective log template of the log templates is based on characteristics of events relating to log entries represented by the respective log template. The system receives a plurality of log entries for a plurality of components in a computing environment, and filters the plurality of log entries to produce a filtered collection of log entries, where the filtering comprises excluding, from the filtered collection of log entries, a log entry of the plurality of log entries that is represented by a log template assigned a score that fails to satisfy a usefulness criterion. The system triggers a remediation action in the computing environment based on the filtered collection of log entries.

### BACKGROUND

A computing environment can include various components that operate to perform tasks. The components can include program components such as application programs, operating systems (OSes), containers, pods, virtual machines (VMs), services, or other types of program components. The components may also include physical components, such as computers, communication nodes, storage systems, processors, input/output (I/O) devices, or other types of electronic components.

### BRIEF DESCRIPTION OF THE DRAWINGS

Some implementations of the present disclosure are described with respect to the following figures.

FIG. 1 is a block diagram of a computing environment including a log filter and a log handling system, according to some examples.

FIG. 2 is a flow diagram of a log templates collection population process, according to some examples.

FIG. 3 is a flow diagram of a log filtering process, according to some examples.

FIG. 4 is a block diagram of a storage medium storing machine-readable instructions according to some examples.

FIG. 5 is a block diagram of a system according to some examples.

FIG. 6 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Log data can be collected for components as they operate in a computing environment. The log data includes information collected relating to activities of the components. In some examples, program developers can add diagnostic program instructions to code of program components. The diagnostic program instructions when executed during operation of a program component collects log data that is emitted to a log data aggregator. Log data can be collected for multiple program components and sent to the log data aggregator. In further examples, sensors (including software sensors or hardware sensors) can collect log data for program components and physical components, and the log data collected by the sensors can also be sent to the log data aggregator.

In a large computing environment with many components, the volume of log data (included in of log entries) generated for the components can be quite large. It can be difficult to determine which log entries are useful for triggering remediation actions and which log entries are not useful for triggering remediation actions. Capturing and storing all the log entries can consume large amounts of processing and storage resources, which leads to increased costs for the operator of the computing environment. Generating an incident based on the log data can involve performing a search through the large volume of log entries, which also consumes processing resources. In some cases, incidents based on the log data may be delayed or not triggered if insufficient processing resources are allocated to process the log data. If incidents are delayed or not triggered, the operator of the computing environment may not be made aware of errors, failures, or attacks in the computing environment, which can lead to operational failures or security risks if remediation actions are not taken in a timely manner.

In accordance with some implementations of the present disclosure, a log management system includes a log filter and a log template management engine. The log template management engine computes scores for log templates mapped to log entries containing log data, where a score computed for a respective log template is based on characteristics of events relating to log entries represented by the respective log template. The log template management engine populates a log templates collection including entries that associate log templates with respective scores. The log filter filters a plurality of log entries for a plurality of components in a computing environment, where the filtering uses the scores to produce a filtered collection of log entries. More specifically, the filtering includes matching the plurality of log entries to log templates in the log templates collection, and using the score assigned a matching log template (matched to a log entry) in the log templates collection to determine whether the log entry is useful. A log entry determined to be not useful is excluded from the filtered collection of log entries. A log entry determined to be useful is added to the filtered collection of log entries. A remediation action is triggered in the computing environment based on the filtered collection of log entries.

The score computed for the respective log template can be based on various characteristics of events relating to log entries, including any or some combination of the following, for example: (1) whether an incident relating to the log entries represented by the respective log template was handled by a support entity (e.g., support personnel, a support program, or a support machine); (2) a severity of an incident generated from the log entries represented by the respective log template; (3) how many support cases were generated to handle incidents relating to the log entries represented by the respective log template, or (4) a property of an outage or an anomaly associated with the log entries represented by the respective log template. For characteristic (4), the property can be a duration of the outage or anomaly, what portion of the computing environment was affected by the outage or anomaly, what users or devices were affected by the outage or anomaly, or any other property.

The log management system according to some examples of the present disclosure improves computer functionality or the relevant technology by enhancing the efficiency of log data processing based on filtering log entries that are deemed not be useful. Log entries that are not useful may be removed. Filtering the log entries produces a reduced set of log entries that can be efficiently processed (such as with a smaller quantity of resources or with resources of smaller capacity) to increase the likelihood that errors, failures, or attacks in a computing environment are dealt with in a timely manner. Timely handling of errors, failures, or attacks reduces the likelihood of operational failures that can cause data loss or security issues, which improves computer functionality of the computing environment.

A "log entry" can refer to a log message (or any other unit of information) that contains one or more variables associated with a component. Each variable in a log entry is assigned a specific value based on a property of a component (or a host device in which the component runs) and/or an operation of the component.

Examples of variables in a log entry can include any or some combination of the following: a name or identifier (e.g., a network address such as an Internet Protocol (IP) address) of a host device in which the component runs, a timestamp, a name of a pod or container or virtual machine (VM), a call made to an application programming interface (API), a filename of a file accessed (or more generally, an identifier of an object accessed), a metric (e.g., indicating a performance or utilization of a component), error information, or any other variable.

A “log template” can refer to a data structure that includes a set of variables that can be assigned specific values in respective log entries. A “set” of variables can include a single variable or multiple variables. Multiple different log entries can map to a log template if the different log entries have arrangements of variables that are similar (based on a similarity criterion) to an arrangement of variables in the log template. Different log templates have different sets of variables.

In some examples, log templates can be generated using a log template miner, such as Drain3 (an open-source log template miner) or a machine-learning based log template miner. The log template miner can process unstructured log entries to derive log templates based on clustering similar log entries, where each cluster of log entries can be represented by a respective log template.

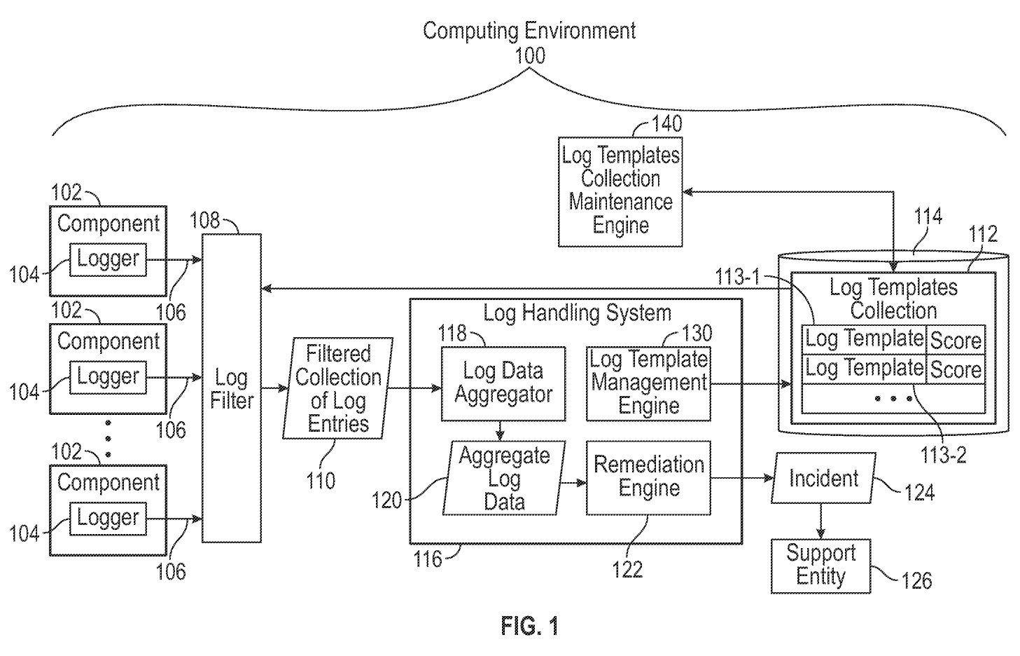

FIG. 1 is a block diagram of an example computing environment 100 that includes various components 102. The computing environment 100 can include a data center, a cloud computing environment, or any other type of computing environment.

The components 102 include program components and/or physical components. Each component 102 includes a respective logger 104. In some examples, a logger can include diagnostic program instructions of a program component to log data during execution of the program component. In other examples, a logger can include a sensor (e.g., a software sensor or hardware sensor) that collects log data (e.g., metrics) for program or physical components.

The log data acquired by a logger 104 forms part of a log entry. The loggers 104 provide log entries 106 to a log filter 108, which filters the log entries 106 to produce a filtered collection of log entries 110. The filtered collection of log entries 110 excludes any log entries 106 that are filtered (removed) based on a log templates collection 112 in a data repository 114. The data repository 114 is implemented with one or more storage devices.

The log templates collection 112 includes multiple entries 113-1, 113-2, and so forth. Each entry in the log templates collection 112 contains a respective log template and a score assigned to the respective log template. The score for the respective log template is computed based on various characteristics listed above, for example. The log templates collection 112 can be in the form of a table, a file, or any other data structure.

The log filter 108 applies filtering of the log entries 106 by matching the log entries 106 to the log templates in the log templates collection 112. “Matching” a log entry to a log template includes comparing a set of variables in the log entry to a set of variables in the log template. In some examples, a match of the log entry and the log template is indicated if the set of variables in the log entry is identical to the set of variables in the log template. In further examples, a match of the log entry and the log template is indicated if the set of variables in the log entry satisfies a similarity criterion to the set of variables in the log template. For example, the similarity criterion is satisfied if greater than X% the set of variables in the log entry match the set of variables in the log template, where X can be 95, 90, 85, 80, 75, 70, and so forth.

Assuming a log entry is matched to a given log template in the log templates collection 112, the log filter 108 determines whether the log entry is useful based on the score for the given log template included in the log templates collection 112. The log filter 108 can determine whether the score for the given log template satisfies a usefulness criterion. If the score for the given log template satisfies the usefulness criterion, the log entry is deemed to be useful. On the other hand, if the score for the given log template does not satisfy the usefulness criterion, the log entry is deemed to be not useful.

The log filter 108 excludes, from the filtered collection of log entries 110, any log entry 106 that is deemed to be not useful based on a score of a matching log template in the log templates collection 112. The log filter 108 adds a log entry 106 matching a log template in the log templates collection 112 to the filtered collection of log entries 110.

In some examples, the usefulness criterion includes a score threshold. A score of a log template that has a specified relationship with the score threshold is deemed to satisfy the usefulness criterion. For example, if a higher score of a log template indicates that a log entry represented by the log template is more useful than an entry represented by a log template with a lower score, then the usefulness criterion is satisfied if the score of a log template exceeds the score threshold. A log entry represented by a log template whose score is less than the score threshold is suppressed, i.e., not included in the filtered collection of log entries 110. In alternative examples where a lower score of a log template indicates that the log template is more useful, then the usefulness criterion is satisfied if the score of the log template is less than the score threshold

The filtered collection of log entries 110 is provided to a log handling system 116. The log handling system 116 includes a log data aggregator 118, a remediation engine 122, and a log template management engine 130.

The log data aggregator 118 aggregates log entries of the filtered collection of log entries 110 into aggregate log data 120, which can be in the form of a log file, a log database, or any other log object. The log data aggregator 118 provides the aggregate log data 120 to the remediation engine 122.

The remediation engine 122 processes the aggregate log data 120 and performs a remediation action based on the aggregate log data 120. An example of a remediation action includes generating an incident 124 for handling by a support entity 126. The support entity 126 may include any combination of support personnel, a support program, or a support machine. An “incident” can refer to an alert or any other indication that an issue in the computing environment 100 has been detected.

The support entity 126 can produce a support case to handle one or more incidents 124. A “support case” can refer to an identified investigative process for analyzing one or more support incidents 124. As incidents 124 are generated by the remediation engine 122 in response to log entries 106, additional support cases are produced by the support entity 126.

Other examples of remediation actions that can be taken by the remediation engine 122 include any or some combination of the following: disabling a component 102 (e.g., shutting down the component, disabling a network connectivity to the component, etc.); isolating a portion of the computing environment 100 that includes one or more components 102 associated with issues as indicated by the aggregate log data 120; updating or replacing machine-readable instructions or physical hardware of a component 102; initiating a malware scan; increasing a security level in the computing environment 100; or any other remediation action.

The log template management engine 130 can include a log template miner (not shown) that generates log templates from a sample of log entries. Note that the log template miner can continue to generate additional log templates as more log entries are received by the log template miner. In other examples, the log template miner separate from the log template management engine 130.

The log template management engine 130 computes scores for each log template based on characteristics of events relating to log entries represented by the log template. Various characteristics on which scores are computed are listed further above.

In an example, a score for a log template can be computed based on whether an incident relating to the log entries represented by the log template was handled by a support entity (e.g., 126 in FIG. 1). The log template management engine 130 can set a higher score for the log template if incident(s) generated in response to log entries represented by the log template was (were) handled by a support entity. On the other hand, the log template management engine 130 can set a lower score for the log template if incident(s) generated in response to log entries represented by the log template was (were) not handled by a support entity. More generally, the score computed for the log template is proportional to the quantity of incidents that were handled by a support entity, where the incidents were generated in response to log entries represented by the log template.

In a further example, a score for a log template can be computed based on a severity of an incident generated from the log entries represented by the log template. The log template management engine 130 can set a higher score for the log template if incident(s) generated in response to log entries represented by the log template has (have) a higher severity level. On the other hand, the log template management engine 130 can set a lower score for the log template if incident(s) generated in response to log entries represented by the log template has (have) a lower severity level. More generally, the score computed for the log template is proportional to the severity level(s) of the incident(s) generated in response to log entries represented by the log template.

In another example, a score for a log template can be computed based on how many support cases were generated to handle incidents relating to the log entries represented by the log template. The log template management engine 130 can set a higher score for the log template for a greater quantity of support cases generated to handle incidents relating to the log entries represented by the log template.

In an additional example, a score for a log template can be computed based on a property of an outage or an anomaly associated with the log entries represented by the log template, where the property can be a duration of the outage or anomaly, what portion of the computing environment 100 was affected by the outage or anomaly, what users or devices were affected by the outage or anomaly, or any other property. A higher score may be set if the outage or anomaly has a longer duration and/or a larger portion of the computing environment 100 was affected by the outage or anomaly. A higher score may also be set if more important users of devices (e.g., users in the executive office or devices associated with users in the executive office) were affected by the outage or anomaly.

Note that a score for a log template can be based on multiple characteristics such as those discussed above.

A log templates collection maintenance engine 140 can maintain the log templates collection 112. Over time, some of the log templates in the log templates collection 112 may no longer be relevant. For example, after a particular log template has been added to the log templates collection 112, further log entries mapped to the particular log template may no longer be received. The log templates collection maintenance engine 140 can remove the particular log template from the log templates collection 112.

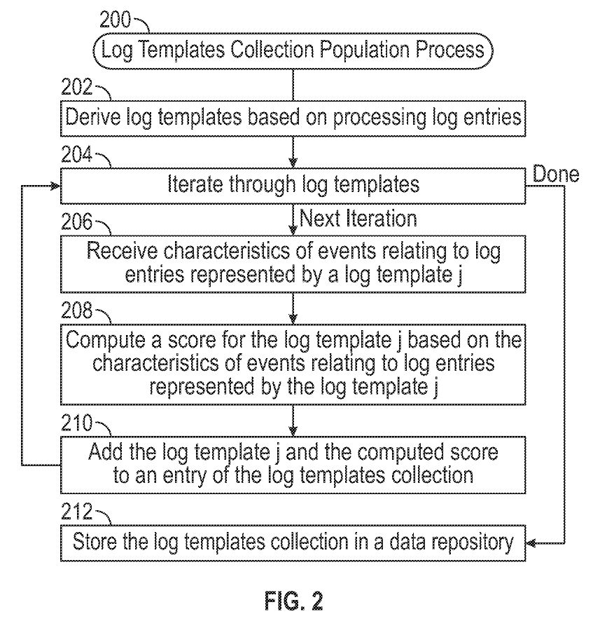

FIG. 2 is a flow diagram of a log templates collection population process 200 of populating the log templates collection 112, which can be performed by the log template management engine 130 according to some examples. A log template miner in the log template management engine 130 derives (at 202) log templates based on processing a sample of log entries. The sample of log entries can be collected over a period of time. Note that the derivation of log templates may be iteratively performed as more log entries are received.

Assuming there are N log templates (N ≥ 1), the process 200 iterates (at 204) through log templates 1 to N. Assuming there are more log templates to process, the log template management engine 130 performs the next iteration and receives (at 206) characteristics of events relating to log entries represented by the log template j, where j = 1 to N, N representing the quantity of log templates to be considered in the process 200.

Based on the characteristics (including one or more of the characteristics discussed above) of events relating to log entries represented by the log template j, the log template management engine 130 computes (at 208) a score for the log template j.

The log template management engine 130 adds (at 210) the log template j and the score computed for the log template j to an entry of the log templates collection 112.

The log template management engine 130 iterates (at 204) through any remaining input log templates, and repeats tasks 206 to 210 for each remaining input log template. After all log templates have been processed by the log template management engine 130, the process 200 is done and the log template management engine 130 stores (at 212) the log templates collection 112 in the data repository 114.

The log template management engine 130 may update the log templates collection 112 as further log entries (e.g., in a new time window) are received and further incidents are generated and outages or and anomalies are detected.

In some examples, the log template management engine 130 can identify a given log template as unique based on a rarity of log entries represented by the given log template. A log entry is “rare” if a set of variables or values assigned to the variables are present in less than a small percentage (e.g., less than 0.05%, 0.02%, 0.01%, or other small percentage) of the universe of observed log entries. The log template management engine 130 precludes the suppression of any log entry matched to the given log template identified as unique. It is noted that keeping the rare log entries (i.e., not removing the rare log entries) would not meaningfully add to the processing and storage burden for handling log entries.

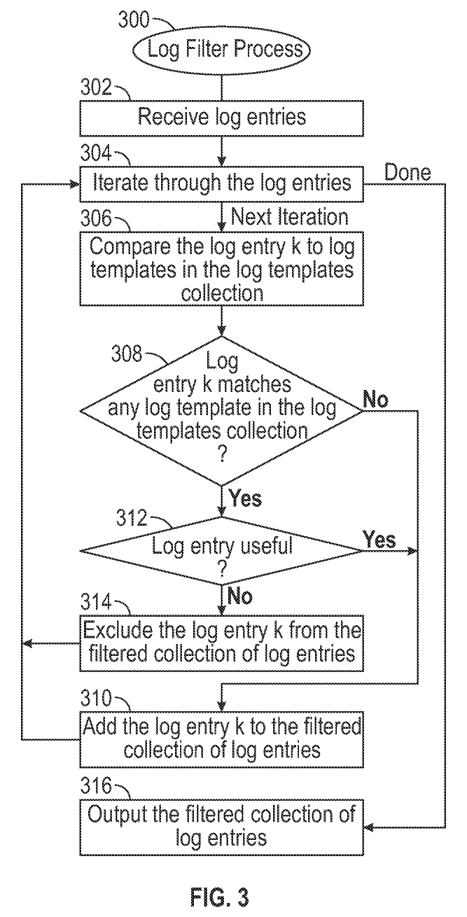

FIG. 3 is a flow diagram of a log filtering process 300, which can be performed by the log filter 108 according to some examples. The log filter 108 receives (at 302) log entries from loggers 104 in respective components 102 (FIG. 1). The log filtering process 300 is an iterative process performed for respective log entries. Assuming there are M log entries (M ≥ 1), the log filtering process 300 iterates (at 304) through log templates 1 to M. Assuming there are more log entries to process, the log filter 108 performs the next iteration and compares (at 306) a log entry k (k = 1 to N) to log templates in the log templates collection 112. More specifically, the log filter 108 compares a set of variables in the log entry k to a set of variables in each log template.

The log filter 108 determines (at 308) whether the log entry k matches any log template in the log templates collection 112. If the log entry k does not match any log template in the log templates collection 112, the log filter 108 adds (at 310) the log entry k to the filtered collection of log entries 110. The log entry k that does not match any log template is considered a log entry of an unknown type. Such a log entry may be useful for detecting issues in the computing environment 100, so the log entry should not be suppressed.

If the log entry k matches a log template in the log templates collection 112, the log filter 108 determines (at 312) whether the log entry k is useful. The log entry k is useful if the score assigned to the matching log template in the log templates collection 112 satisfies the usefulness criterion. The log entry k is not useful if the score assigned to the matching log template in the log templates collection 112 does not satisfy the usefulness criterion.

If the log filter 108 determines (at 312) that the log entry k is useful, the log filter 108 adds (at 310) the log entry k to the filtered collection of log entries 110. However, if the log filter 108 determines (at 312) that the log entry k is not useful, the log filter 108 excludes (at 314) the log entry k from the filtered collection of log entries 110.

The log filter 108 iterates (at 304) through any remaining log entries by repeating tasks 306 to 314 for each remaining log entry. After all log entries have been processed by the log filter 108, the log filter process 300 is done and the log filter 108 outputs (at 316) the filtered collection of log entries 110 to the log handling system 116.

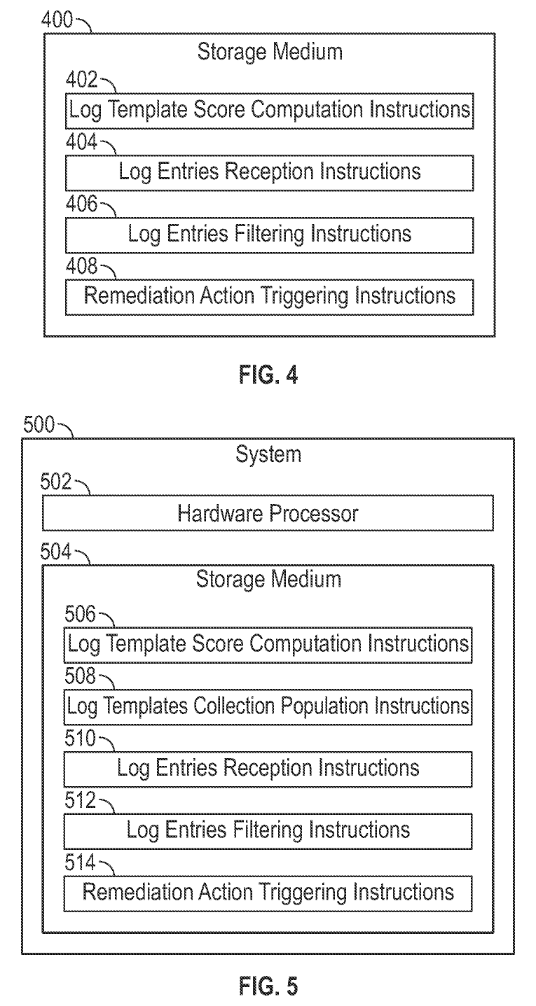

FIG. 4 is a block diagram of a non-transitory machine-readable or computer-readable storage medium 400 storing machine-readable instructions that upon execution cause a system to perform various tasks. The system may include one or more computers.

The machine-readable instructions include log template score computation instructions 402 to compute scores for log templates mapped to log entries containing log data. A score computed for a respective log template of the log templates is based on characteristics of events relating to log entries represented by the respective log template. A log template can represent a collection of similar log entries.

The machine-readable instructions include log entries reception instructions 404 to receive a plurality of log entries for a plurality of components in a computing environment. Each log entry can include a set of variables that are set to respective values.

The machine-readable instructions include log entries filtering instructions 406 to filter the plurality of log entries to produce a filtered collection of log entries. The filtering is performed by excluding, from the filtered collection of log entries, a log entry of the plurality of log entries that is represented by a first log template assigned a score that fails to satisfy a usefulness criterion.

The machine-readable instructions include remediation action triggering instructions 408 to trigger a remediation action in the computing environment based on the filtered collection of log entries. The remediation action can address an issue associated with at least some of the log entries in the filtered collection of log entries.

In some examples, the machine-readable instructions can produce a log templates collection that associates the log templates with the scores assigned the log templates. The filtering uses the log templates collection.

In some examples, the machine-readable instructions can determine whether a first log entry matches any log template in the log templates collection. The machine-readable instructions can add the first log entry to the filtered collection of log entries based on determining that the first log entry does not match any log template in the log templates collection.

In some examples, the machine-readable instructions can determine whether a second log entry matches any log template in the log templates collection. The machine-readable instructions can obtain a score of a matching log template from the log templates collection, where the second log entry is matched to the matching log template. The machine-readable instructions can determine whether the score of the matching log template satisfies the usefulness criterion, and based on determining that the score of the matching log template satisfies the usefulness criterion, the machine-readable instructions can add the second log entry to the filtered collection of log entries.

In some examples, the machine-readable instructions can identify a second log template in the log templates collection for which further log entries have not been received, and the machine-readable instructions can remove the second log template from the log templates collection.

In some examples, excluding log entries represented by the first log template assigned the score that fails to satisfy the usefulness criterion from the filtered collection of log entries is temporary.

In some examples, the machine-readable instructions can update scores for the log templates based on log entries in a new time window (the scores are updated for the log templates based on new log entries and handling of the new log entries). Based on an updated score for the first log template satisfying the usefulness criterion, the machine-readable instructions can add a further log entry represented by the first log template to the filtered collection of log entries.

In some examples, each corresponding log template of the log templates includes a respective set of variables present in log entries represented by the corresponding log template. In some examples, a first set of variables contained in a first log template is different from a second set of variables contained in a second log template. In some examples, the log entries represented by the corresponding log template include different values assigned the respective set of variables.

In some examples, the score computed for the respective log template is based on whether an incident relating to the log entries represented by the respective log template was handled by a support entity; or the score computed for the respective log template is based on a severity of an incident generated from the log entries represented by the respective log template; or the score computed for the respective log template is based on how many support cases were generated to handle incidents relating to the log entries represented by the respective log template; or wherein the score computed for the respective log template is based on a property of an outage or an anomaly associated with the log entries represented by the respective log template.

In some examples, the machine-readable instructions can identify a given log template as unique based on a rarity of log entries represented by the given log template. The machine-readable instructions can preclude any suppression of a log entry represented by the given log template identified as unique from the filtered collection of log entries.

FIG. 5 is a block diagram of a system 500 according to some examples of the present disclosure. The system 500 can include one or more computers.

The system 500 includes a hardware processor 502 (or multiple hardware processors). A hardware processor can include a microprocessor, a core of a multi-core microprocessor, a microcontroller, a programmable integrated circuit, a programmable gate array, or another hardware processing circuit.

The system 500 includes a storage medium 504 storing machine-readable instructions executable on the hardware processor 502 to perform various tasks. Machine-readable instructions executable on a hardware processor can refer to the instructions executable on a single hardware processor or the instructions executable on multiple hardware processors.

The machine-readable instructions in the storage medium 504 include log template score computation instructions 506 to compute scores for log templates, where a score computed for a respective log template of the log templates is based on characteristics of events relating to log entries represented by the respective log template.

The machine-readable instructions in the storage medium 504 include log templates collection population instructions 508 to add, to a log templates collection, log templates and the scores assigned to the log templates.

The machine-readable instructions in the storage medium 504 include log entries reception instructions 510 to receive a plurality of log entries for a plurality of components in a computing environment.

The machine-readable instructions in the storage medium 504 include log entries filtering instructions 512 to produce, based on the log templates collection, a filtered collection of log entries by filtering the plurality of log entries based on matching the plurality of log entries to the log templates collection. The filtering includes excluding, from the filtered collection of log entries, a firs log entry that is represented by a first log template assigned a score that fails to satisfy a usefulness criterion.

The machine-readable instructions in the storage medium 504 include remediation action triggering instructions 514 to trigger a remediation action in the computing environment based on the filtered collection of log entries.

In some examples, the filtering includes adding, to the filtered collection of log entries, a second log entry of the plurality of log entries that is represented by a second log template assigned a score that satisfies the usefulness criterion.

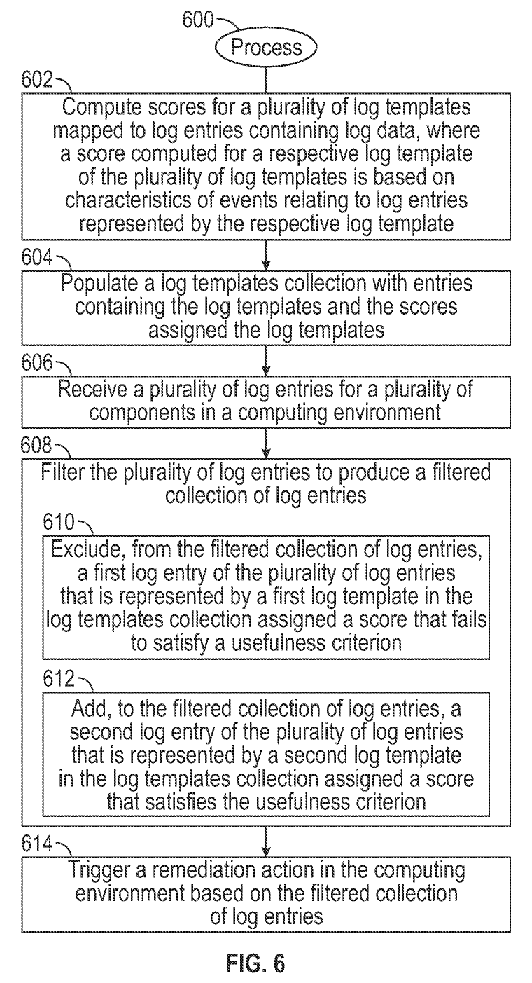

FIG. 6 is a flow diagram of a process 600 according to some examples of the present disclosure. The process 600 includes computing (at 602) scores for a plurality of log templates mapped to log entries containing log data, where a score computed for a respective log template of the plurality of log templates is based on characteristics of events relating to log entries represented by the respective log template.

The process 600 includes populating (at 604) a log templates collection with entries containing the log templates and the scores assigned the log templates.

The process 600 includes receiving (at 606) a plurality of log entries for a plurality of components in a computing environment. The log entries can be sent from loggers in the components.

The process 600 includes filtering (at 608) the plurality of log entries to produce a filtered collection of log entries. The filtering includes excluding (at 610), from the filtered collection of log entries, a first log entry of the plurality of log entries that is represented by a first log template in the log templates collection assigned a score that fails to satisfy a usefulness criterion. The filtering further includes adding (at 612), to the filtered collection of log entries, a second log entry of the plurality of log entries that is represented by a second log template in the log templates collection assigned a score that satisfies the usefulness criterion.

The process 600 includes triggering (at 614) a remediation action in the computing environment based on the filtered collection of log entries.

As used here, an "engine" can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an "engine" can refer to a combination of one or more hardware processing circuits and machine-readable instructions (software and/or firmware) executable on the one or more hardware processing circuits.

FIGS. 2, 3, and 6 shows specific orders of tasks. In other examples, the tasks may be performed in a different order, some of the tasks may be omitted, and other tasks may be added.

A storage medium (e.g., 400 in FIG. 4 or 504 in FIG. 5) can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term "a," "an," or "the" is intended to include the plural forms as well, unless the context clearly indicates otherwise. Also, the term "includes," "including," "comprises," "comprising," "have," or "having" when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
compute scores for log templates mapped to log entries containing log data, wherein a score computed for a respective log template of the log templates is based on characteristics of events relating to log entries represented by the respective log template;
receive a plurality of log entries for a plurality of components in a computing environment;
filter the plurality of log entries to produce a filtered collection of log entries, wherein the filtering comprises excluding, from the filtered collection of log entries, a log entry of the plurality of log entries that is represented by a first log template assigned a score that fails to satisfy a usefulness criterion; and
trigger a remediation action in the computing environment based on the filtered collection of log entries.

2. The non-transitory machine-readable storage medium of claim 1, wherein the instructions upon execution cause the system to:
produce a log templates collection that associates the log templates with the scores assigned the log templates,
wherein the filtering uses the log templates collection.

3. The non-transitory machine-readable storage medium of claim 2, wherein the instructions that upon execution cause the system to:
determine whether a first log entry matches any log template in the log templates collection; and
add the first log entry to the filtered collection of log entries based on determining that the first log entry does not match any log template in the log templates collection.

4. The non-transitory machine-readable storage medium of claim 3, wherein the instructions that upon execution cause the system to:
determine whether a second log entry matches any log template in the log templates collection;
obtain a score of a matching log template from the log templates collection;
determine whether the score of the matching log template satisfies the usefulness criterion; and
based on determining that the score of the matching log template satisfies the usefulness criterion, add the second log entry to the filtered collection of log entries,

5. The non-transitory machine-readable storage medium of claim 2, wherein the instructions upon execution cause the system to:
identify a second log template in the log templates collection for which further log entries have not been received; and
remove the second log template from the log templates collection.

6. The non-transitory machine-readable storage medium of claim 1, wherein excluding log entries represented by the first log template assigned the score that fails to satisfy the usefulness criterion from the filtered collection of log entries is temporary.

7. The non-transitory machine-readable storage medium of claim 6, wherein the instructions upon execution cause the system to:
update scores for the log templates based on log entries in a new time window; and
based on an updated score for the first log template satisfying the usefulness criterion, add a further log entry represented by the first log template to the filtered collection of log entries.

8. The non-transitory machine-readable storage medium of claim 1, wherein each corresponding log template of the log templates comprises a respective set of variables present in log entries represented by the corresponding log template.

9. The non-transitory machine-readable storage medium of claim 8, wherein a first set of variables contained in a first log template is different from a second set of variables contained in a second log template.

10. The non-transitory machine-readable storage medium of claim 8, wherein the log entries represented by the corresponding log template comprise different values assigned the respective set of variables.

11. The non-transitory machine-readable storage medium of claim 1, wherein the score computed for the respective log template is based on whether an incident relating to the log entries represented by the respective log template was handled by a support entity.

12. The non-transitory machine-readable storage medium of claim 1, wherein the score computed for the respective log template is based on a severity of an incident generated from the log entries represented by the respective log template.

13. The non-transitory machine-readable storage medium of claim 1, wherein the score computed for the respective log template is based on how many support cases were generated to handle incidents relating to the log entries represented by the respective log template.

14. The non-transitory machine-readable storage medium of claim 1, wherein the score computed for the respective log template is based on a property of an outage or an anomaly associated with the log entries represented by the respective log template.

15. The non-transitory machine-readable storage medium of claim 1, wherein the instructions upon execution cause the system to:
identify a given log template as unique based on a rarity of log entries represented by the given log template; and
preclude any suppression of a log entry represented by the given log template identified as unique.

16. A system comprising:
a hardware processor; and
a non-transitory storage medium storing instructions executable on the hardware processor to:
compute scores for log templates, wherein a score computed for a respective log template of the log templates is based on characteristics of events relating to log entries represented by the respective log template;
add, to a log templates collection, the log templates and the scores assigned to the log templates;
receive a plurality of log entries for a plurality of components in a computing environment;
produce, based on the log templates collection, a filtered collection of log entries by filtering the plurality of log entries based on matching the plurality of log entries to the of log templates collection, wherein the filtering comprises excluding, from the filtered collection of log entries, a first log entry of the plurality of log entries that is represented by a first log template assigned a score that fails to satisfy a usefulness criterion; and
trigger a remediation action in the computing environment based on the filtered collection of log entries.

17. The system of claim 16, wherein the filtering comprises adding, to the filtered collection of log entries, a second log entry of the plurality of log entries that is represented by a second log template assigned a score that satisfies the usefulness criterion.

18. The system of claim 16, wherein the instructions are executable on the hardware processor to:
update scores for the log templates based on new log entries and handling of the new log entries;
based on an updated score for the first log template satisfying the usefulness criterion, add a further log entry represented by the first log template to the filtered collection of log entries.

19. A method comprising:
computing, by a system comprising a hardware processor, scores for a plurality of log templates mapped to log entries containing log data, wherein a score computed for a respective log template of the plurality of log templates is based on characteristics of events relating to log entries represented by the respective log template;
populating, by the system, a log templates collection with entries containing the log templates and the scores assigned the log templates;
receiving, by the system, a plurality of log entries for a plurality of components in a computing environment;
filtering, by the system, the plurality of log entries to produce a filtered collection of log entries, wherein the filtering comprises:
excluding, from the filtered collection of log entries, a first log entry of the plurality of log entries that is represented by a first log template in the log templates collection assigned a score that fails to satisfy a usefulness criterion, and
adding, to the filtered collection of log entries, a second log entry of the plurality of log entries that is represented by a second log template in the log templates collection assigned a score that satisfies the usefulness criterion; and
triggering, by the system, a remediation action in the computing environment based on the filtered collection of log entries.

20. The method of claim 19, wherein the score computed for the respective log template is based on the characteristics comprising on one or more of
whether an incident relating to the log entries represented by the respective log template was handled by a support entity,
a severity of an incident generated from the log entries represented by the respective log template,
how many support cases were generated to handle incidents relating to the log entries represented by the respective log template, or
a property of an outage or an anomaly associated with the log entries represented by the respective log template.
